(19) United States
(12) Patent Application Publication
(10) Pub. No.: US 2025/0285517 A1
(43) Pub. Date: Sep. 11, 2025

(54) POINT-OF-SALE TERMINAL, METHOD, AND MEDIUM

(71) Applicant: Toshiba Tec Kabushiki Kaisha, Tokyo (JP)

(72) Inventor: Shintaro HARADA, Izunokuni Shizuoka (JP)

(21) Appl. No.: 19/011,492

(22) Filed: Jan. 6, 2025

(30) Foreign Application Priority Data
Mar. 7, 2024 (JP) 2024-034971

(51) Int. Cl. G07G 1/01; G06T 7/70; G07G 1/00

(52) U.S. Cl. CPC G07G 1/01; G06T 7/70; G07G 1/0045; G06T 2207/20132

(57) ABSTRACT

A point-of-sale terminal includes a processor configured to: control a camera to capture an image, determine whether an object is present therein, upon determining that an object is present, execute a recognition process including an appearance recognition process for recognizing the object based on its appearance and a symbol recognition process for recognizing the object using its symbol, when a candidate item is output, register the candidate item as an item to be purchased, and when two or more candidate items are output, determine whether the items have similar appearances, upon determining that the items have similar appearances, control a display to display a first guidance screen with an instruction to change a position or orientation of the object, and upon determining that the items do not have similar appearances, control the display to display a second guidance screen with an instruction to turn a symbol towards the camera.

### CROSS-REFERENCE TO RELATED APPLICATION(S)

This application is based upon and claims the benefit of priority from Japanese Patent Application No. 2024-034971, filed Mar. 7, 2024, the entire contents of which are incorporated herein by reference.

### FIELD

Embodiments described herein relate generally to a point-of-sale (POS) terminal, a method, and a medium.

### BACKGROUND

A registration system is known in which a customer operates a terminal to capture an image of an item placed in a shopping cart in a store and register the item. A POS system using such a registration system is sometimes referred to as a friction-less or cart POS system.

However, such a POS system is not always able to correctly recognize an item, and if the recognition fails, the customer needs to find out how to deal with the failure by themselves.

### SUMMARY OF THE INVENTION

Embodiments of the present disclosure provide a POS terminal, a method, and a medium for providing guidance for registering an item properly when a recognition process fails.

A POS terminal for registering an item for purchase at a store, comprises a display; a camera; and a processor configured to: control the camera to capture an image, determine whether an object is present in the image, upon determining that an object is present in the image, execute a recognition process on the image, the recognition process including an appearance recognition process for recognizing the object based on an appearance thereof and a symbol recognition process for recognizing the object using a symbol attached thereto, when a single candidate item is output through the recognition process, register the single candidate item as an item to be purchased, and when two or more candidate items are output through the recognition process, determine whether the two or more candidate items have similar appearances, upon determining that the two or more candidate items have similar appearances, control the display to display a first guidance screen with an instruction to change a position or orientation of the object in the image, and then execute the recognition process again, and upon determining that the two or more candidate items do not have similar appearances, control the display to display a second guidance screen with an instruction to turn a symbol attached to the object towards the camera, and then execute the recognition process again.

### BRIEF DESCRIPTION OF THE DRAWINGS

FIG. 1 is a block diagram illustrating a schematic configuration of a transaction processing system according to an embodiment.

FIG. 2 is a perspective view illustrating a cart to which a cart terminal is attached.

FIG. 3 is a flowchart of a registration process.

FIG. 4 is a flowchart of a registration process.

FIG. 5 is a flowchart of a registration process.

### DETAILED DESCRIPTION

Hereinafter, embodiments will be described in detail with reference to the drawings. The present invention is not limited to the embodiments described below.

Hereinafter, a transaction processing system 1 with the functions of an item recognition system will be described.

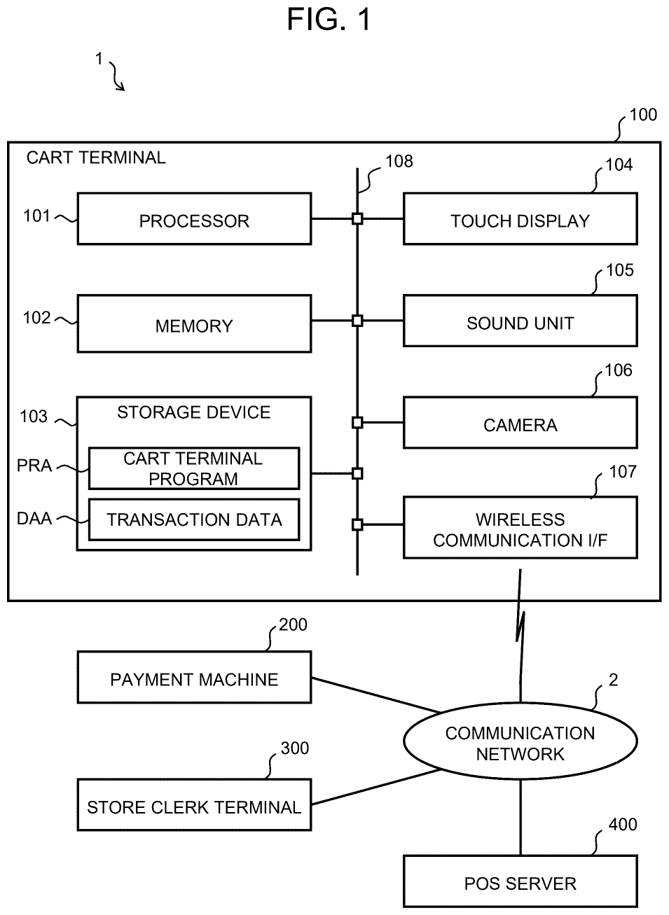

FIG. 1 is a block diagram illustrating a schematic configuration of the transaction processing system 1 including a cart terminal 100 according to an embodiment.

The transaction processing system 1 includes the cart terminal 100, a payment machine 200, a store clerk terminal 300, and a POS server 400, which are connected to each other via a communication network 2.

As the communication network 2, the Internet, a VPN (virtual private network), a LAN (local area network), a public communication network, a mobile communication network, or the like can be used alone or in combination as appropriate. As the communication network 2, for example, a LAN and the Internet are used in combination.

The transaction processing system 1 may include any number of cart terminals 100, payment machines 200, store clerk terminals 300, and POS servers 400, but only one of each is shown in FIG. 1.

The cart terminal 100 is an information processing terminal attached to a shopping cart provided in a store (hereinafter simply referred to as a cart). The cart terminal 100 is loaned together with the cart to a customer who purchases an item at a store. The cart terminal 100 is a terminal device that executes a transaction process in which a customer registers an item to be purchased as a transaction item in response to an operation by the customer. The user of the cart terminal 100 is a customer who uses the cart terminal 100 in this manner. As will be described later, the cart terminal 100 normally executes a process of identifying an item to be registered as a transaction item from an image of the item. That is, the cart terminal 100 has a function as an item registration system.

The payment machine 200 is installed in a store and executes a payment process related to payment of the price of the transaction item registered by the cart terminal 100. The payment machine 200 receives an operation by an operator at the time of payment process. The operator of the payment machine 200 is mainly a customer. In some cases, the store clerk is an operator of the payment machine 200.

The store clerk terminal 300 is an information processing terminal operated by a store clerk. The store clerk terminal 300 is a terminal device for a user interface related to an information process for assisting a store clerk's operation related to a transaction processed by the transaction processing system 1. The operation of the store clerk is, for example, to monitor the execution status of the transaction being processed and to appropriately assist the customer. The POS server 400 is an information processing apparatus that executes a management process for managing a transaction of an item processed by a transaction process in the cart terminal 100 and a payment process in the payment machine 200.

The cart terminal 100 includes a processor 101, a memory 102, a storage device 103, a touch display 104, a sound unit 105, a camera 106, a wireless communication interface (I/F) 107, a transmission path 108, and the like. The processor 101, the memory 102, the storage device 103, the touch display 104, the sound unit 105, the camera 106, and the wireless communication I/F 107 can communicate with each other via the transmission path 108.

By connecting the processor 101, the memory 102, and the storage device 103 via the transmission path 108, a controller that performs an information process for controlling the cart terminal 100 is configured.

The processor 101 corresponds to a core component of the controller. For example, the processor 101 is a CPU (central processing unit) to execute the information process for controlling each component of the cart terminal 100 and perform various functions thereof in accordance with one or more information processing programs including an operating system and an application program.

The memory 102 includes a read-only memory area and a rewritable memory area. The memory 102 stores a part of the information processing programs in the read-only memory area. In some cases, the memory 102 stores data necessary for the processor 101 to execute a process for controlling each part in the read-only memory area or the rewritable memory area. The memory 102 uses the rewritable memory area as a work area for the processor 101.

The storage device 103 corresponds to an auxiliary storage device of the cart terminal 100. The storage device 103 may be, for example, an EEPROM (electric erasable programmable read-only memory), an HDD (hard disc drive), an SSD (solid state drive), or any other known storage device. The storage device 103 stores data used by the processor 101 to perform various types of processing and data generated by processing by the processor 101. The storage device 103 may store the above-described information processing programs. In an embodiment, the storage device 103 stores a cart terminal program PRA which is one of the information processing programs. The cart terminal program PRA is an application program for executing the transaction process. A part of the storage area of the storage device 103 is used as an area for storing transaction data DAA. The transaction data DAA is data representing the content of one transaction.

The touch display 104 includes a touch panel and displays a screen for presenting information to the operator. Further, the touch display 104 receives an instruction by a touch operation on the screen by the operator.

The sound unit 105 is a speaker that outputs sounds for various guidance and alarms. As the sound unit 105, various well-known sound devices such as a speech synthesis device and a buzzer can be used alone or in combination.

The camera 106 captures an image of a shooting range including the entire interior space of the shopping basket placed on the cart. Then, the camera 106 outputs image data representing an image obtained by shooting. Note that the camera 106 may repeat the shooting at a constant cycle, or may perform the shooting in response to an instruction from the processor 101. Instead of the camera 106, an external camera fixed to the cart and connected to the cart terminal 100 may be used.

The wireless communication I/F 107 is a network interface circuit that executes a communication process for wirelessly performing data communication via the communication network 2. As the wireless communication I/F 107, for example, a conventional wireless communication device for wireless LAN can be used. In place of or in addition to the wireless communication I/F 107, a network interface controller (NIC) wired to the communication network 2 may be used.

The transmission path 108 includes an address bus, a data bus, a control signal line, and the like, and conveys data and control signals transmitted and received between the connected components.

As the basic hardware of the cart terminal 100, for example, it is assumed that hardware of a tablet-type information processing apparatus is used. The transfer of the cart terminal 100 is generally performed while the cart terminal program PRA is stored in the storage device 103. However, the hardware in a state in which the cart terminal program PRA is not stored in the storage device 103 or in a state in which the application program of the same type is stored in the storage device 103 and the cart terminal program PRA may be individually transferred. The cart terminal 100 may be configured by writing the cart terminal program PRA in the storage device 103 in accordance with an operation of an operator. The cart terminal program PRA can be copied and installed from a removable recording medium such as a magnetic disk, a magneto-optical disk, an optical disk, a semiconductor memory, or the like, or downloaded via a network.

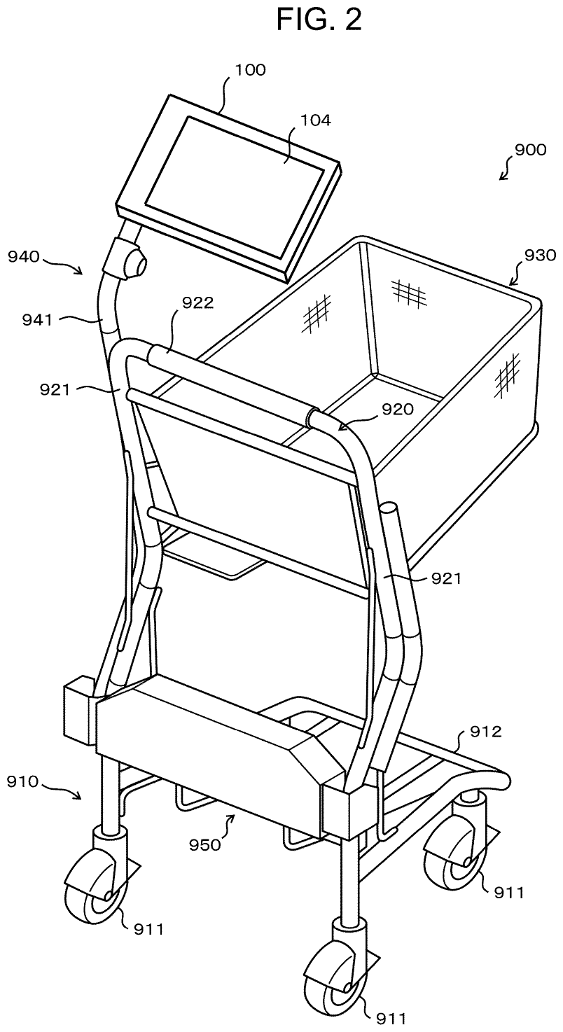

FIG. 2 is a perspective view illustrating a cart 900 to which the cart terminal 100 is attached.

The cart 900 includes a caster unit 910, a handle frame unit 920, a basket unit 930, a support unit 940, and a battery case 950.

The caster unit 910 has four wheels 911 for smoothly moving the cart 900 on the floor. The wheels 911 are attached to a frame 912 to be rotatable about a vertical axis.

The handle frame unit 920 includes a pair of vertical frames 921 and a handlebar 922. The vertical frames 921 are erected above two wheels of the caster unit 910. The handlebar 922 connects the upper end of the vertical frames 921.

The basket unit 930 is provided horizontally from an intermediate portion of the handle frame unit 920. The basket unit 930 has a basket shape in which an upper portion is opened for a customer to put and remove an item, and functions as a container for storing the item to be purchased by the customer.

Thus, the internal space of the basket unit 930 and the space above it serve as a placing space for placing an item.

The support unit 940 includes a pole 941. The pole 941 is attached to one of the vertical frames 921 such that its tip is located above the handlebar 922. The above-described cart terminal 100 is attached to the distal end portion of the pole 941. Thus, the support unit 940 supports the cart terminal 100 in the state shown in FIG. 2. In the state illustrated in FIG. 2, the camera 106 provided in the cart terminal 100 is provided on the surface opposite to the installation surface of the touch display 104, and is not shown in FIG. 2. Thus, the camera 106 is in a state in which an overhead view of the basket unit 930 can be captured.

The battery case 950 is mounted between the vertical frames 921 on the lower end side of the handle frame unit 920. The battery case 950 houses a battery used as an external power source of the cart terminal 100.

Next, the operation of the transaction processing system 1 configured as described above will be described. Note that the contents of the various processes described below are examples, and the order of some of the processes may be changed, some of the processes may be omitted, or other processes may be added as appropriate. For example, in the following description, descriptions of some processes are omitted in order to explain characteristic operations in an easy-to-understand manner. For example, when some kind of error occurs, a process for coping with the error may be performed. Further, for example, in various standby status, occurrence of an event different from that described is also awaited, and the process may be shifted to a process corresponding to the occurrence of the event.

A customer who intends to purchase displayed items sold at a store performs a predetermined operation for starting use on the unused cart terminal 100. When this operation is performed, the processor 101 starts a registration process by executing the cart terminal program PRA.

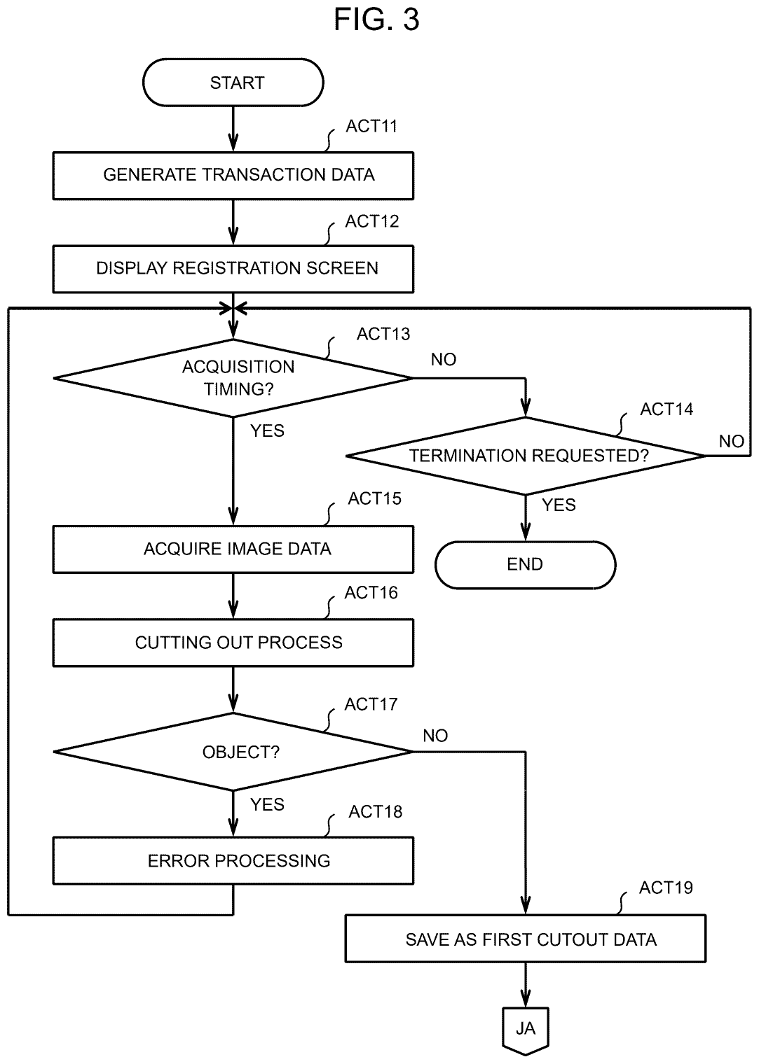

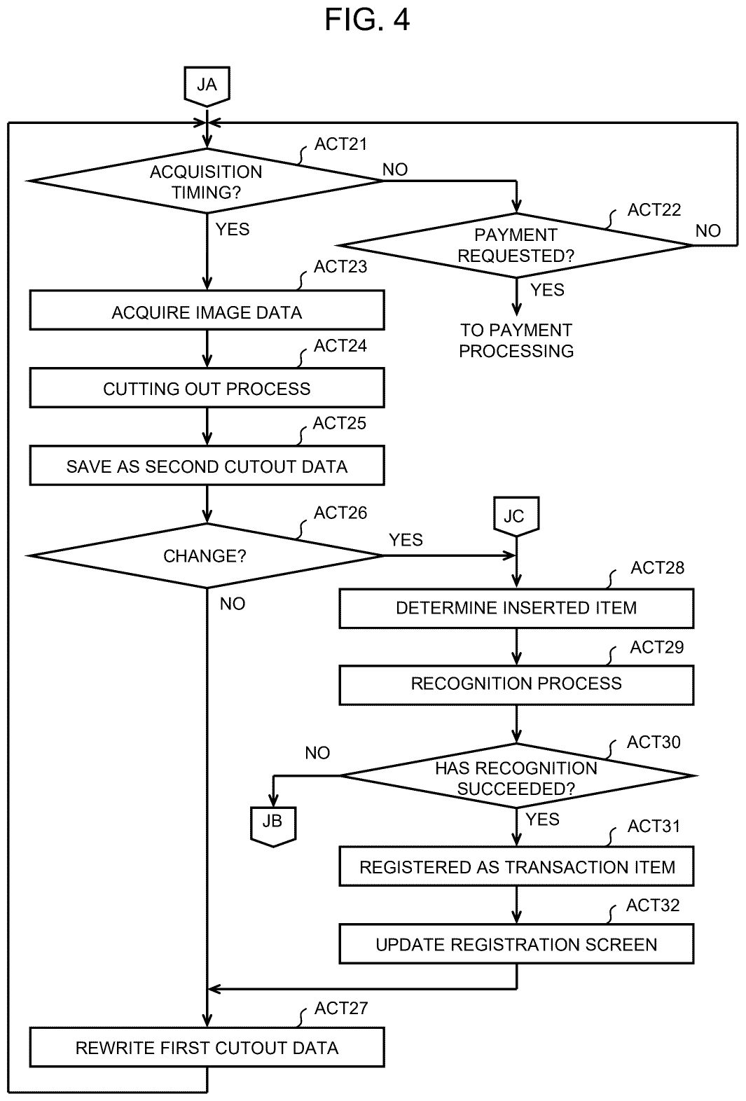

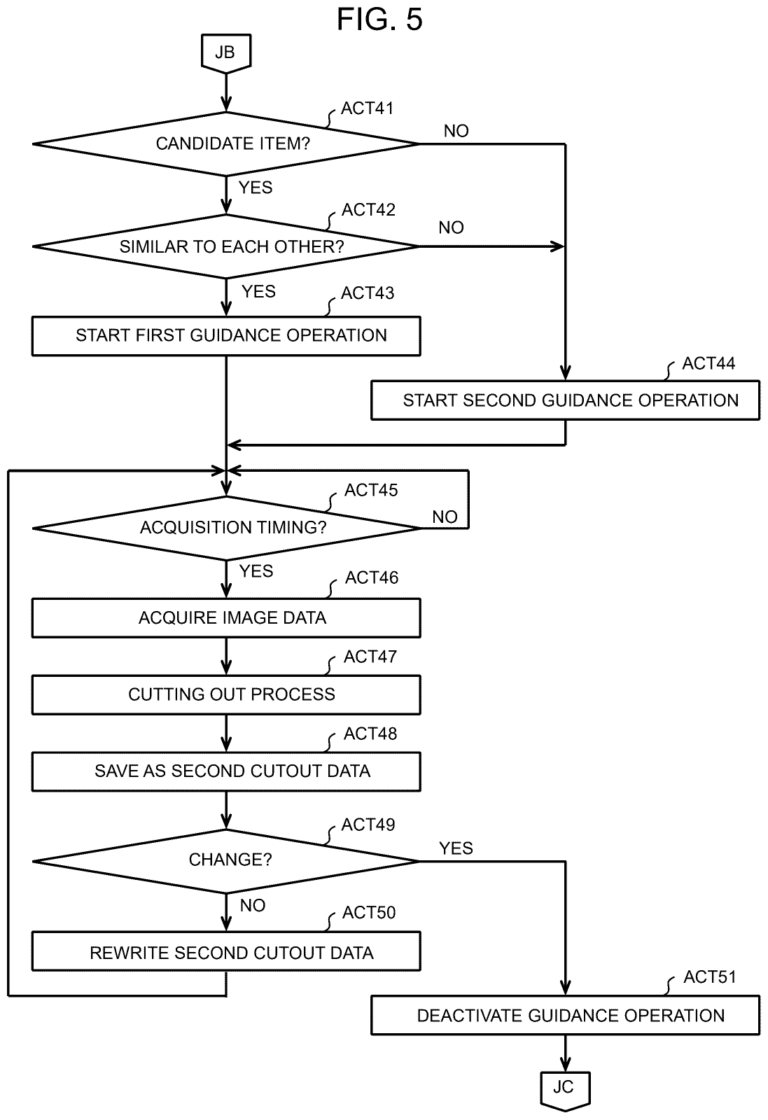

FIG. 3, FIG. 4, and FIG. 5 are flowcharts of the registration process. In ACT11 of FIG. 3, the processor 101 generates new transaction data DAA for a target transaction. That is, the processor 101 determines, for example, a new transaction code as an identifier for identifying the new transaction according to a predetermined rule, generates new transaction data DAA including the transaction code and not including any item information related to transaction items, and stores the new transaction data DAA with the new transaction code in the storage device 103.

In ACT12, the processor 101 causes the touch display 104 to display a registration screen. The registration screen allows the customer to recognize the registration status of each transaction item. That is, the registration screen represents, for example, a list of registered transaction items. However, when ACT12 is executed, since any transaction item has not yet been registered, it is set as a screen for allowing the customer to recognize that any transaction item has not been registered. Note that the registration screen may include any of various display objects in addition to the list of transaction items. An example of the display object included in the registration screen is a character string representing a provisional price amount for the registered transaction items. Another example of the display object included in the registration screen is a soft key for receiving various operations by the customer. The content of the registration screen may be appropriately determined by, for example, the designer of the cart terminal program PRA.

In ACT13, the processor 101 checks whether the acquisition timing comes. The processor 101 determines NO if the corresponding event cannot be confirmed, and proceeds to ACT14.

In ACT14, the processor 101 checks whether termination is requested. The processor 101 then determines NO if the event cannot be ascertained and returns to ACT13. Thus, the processor 101 waits for acquisition timing to occur or termination to be requested in ACT13 and ACT14.

If the customer stops the use of the cart terminal 100 without starting the registration of the item, the customer requests the end by, for example, a predetermined operation on the touch display 104. In response to this, the processor 101 determines YES in ACT14, and ends the registration process.

The acquisition timing is assumed to be, for example, a timing immediately after the advance from ACT12 to ACT13 and a timing at every predetermined time-interval thereafter. The acquisition timing may be appropriately determined by, for example, the designer of the cart terminal program PRA.

When the acquisition timing comes, the processor 101 determines YES in ACT13 and proceeds to ACT15.

In ACT15, the processor 101 acquires image data output by the camera 106. For example, if the camera 106 repeats shooting at a fixed cycle, the processor 101 acquires image data output by the camera 106 in response to the first shooting after the acquisition timing. For example, if the camera 106 captures an image in response to an instruction from the processor 101, the processor 101 instructs the camera 106 to capture an image, and in response, the camera 106 captures an image and acquires image data to be output. The processor 101 stores the acquired image data in the memory 102 or the storage device 103.

In ACT16, the processor 101 performs a cutting out process for the camera images acquired as described above. The cutting out process is a process for clipping each object reflected in the camera image. As the cutting out process, for example, a known image processing technique for clipping an object in an image can be used. For example, a deep learning using CNN (convolutional neural network) or a graph cuts may be used. Note that the cutting out process is not performed until it is determined what the clipped object is.

In ACT17, the processor 101 checks whether there is an object that has been cut out by the above-described cutting out process. Then, if at least one object has been cut out, the processor 101 determines YES and proceeds to ACT18.

The registration process is started when the use of the cart terminal 100 is started, and when ACT15 is executed, the item registration is not started, and in this condition, the item should not be placed in a shopping basket SB. It should be noted that it is desirable that the shopping basket SB is set to be empty at the state of starting use as a usage rule of the cart terminal 100 and is known to the customer. For this purpose, in the cart terminal 100, the processor 101 may cause the touch display 104 to display a screen for guiding the customer to set the shopping basket SB to an empty state when the customer starts the registration process. Therefore, any object should not be shown in the image represented by the image data acquired by ACT15, and if an object is cut out by ACT16 cutting out process, the object is included in the shopping basket SB contrary to the above rule.

In ACT18, the processor 101 performs a predetermined error process. This error process is for dealing with the above-described rule-violation, and what processing is to be performed may be appropriately determined by, for example, the designer of the cart terminal program PRA. For example, the processor 101 controls the touch display 104 to display a screen to guide the customer to empty the shopping basket SB. When the predetermined release condition is satisfied, the processor 101 returns to the standby status of ACT13 and ACT14. Note that, as an example, it is assumed that a predetermined operation for declaring that the guidance on the screen for guiding the customer to empty the shopping basket SB has been confirmed is performed, for example, on the touch display 104. Alternatively, as an example, it is assumed that the release condition is a case where a predetermined waiting period ends.

The processor 101 determines NO in ACT17 if a single object cannot be cut out by the cutting out process in ACT16, and proceeds to ACT19.

In ACT19, the processor 101 saves the data representing the result of the cutting out process in ACT16 in the memory 102 or the storage device 103 as the first cutout data. The processor 101 then transitions to ACT21 and ACT22 standby status in FIG. 4.

In ACT21, the processor 101 checks whether the acquisition timing comes. The processor 101 determines NO if the corresponding event cannot be confirmed, and proceeds to ACT22.

In ACT22, the processor 101 checks whether the payment has been requested. The processor 101 then determines NO if the event cannot be ascertained and returns to ACT21. Thus, the processor 101 waits for the acquisition timing or the payment to be requested in ACT21 and ACT22.

Then, the processor 101 determines YES in ACT21 when the acquisition timing comes, and proceeds to ACT23.

In ACT23, the processor 101 acquires the image data in the same manner as ACT15 in FIG. 3.

In ACT24, the processor 101 performs a cutting out process in the same manner as ACT16 in FIG. 3.

In ACT25, the processor 101 saves the data representing the result of the cutting out process in ACT24 in the memory 102 or the storage device 103 as the second cutout data.

In ACT26, the processor 101 checks whether there is a change in the second cutout data with respect to the first cutout data. Then, if there is no difference between the first cutout data and the second cutout data, the processor 101 determines NO and proceeds to ACT27.

In ACT27, the processor 101 rewrites the second cutout data as new first cutout data. The processor 101 then returns to ACT21 and ACT22 standby status.

Thus, the processor 101 repeatedly acquires image data at each acquisition timing, and waits for a change in the cut-out result regarding the latest image data from the cut-out result regarding the previously acquired image data to occur.

The customer looks for a transaction item in the store. Then, the customer takes out the item to be purchased from the sales floor and puts the item into the basket unit 930. At this time, the item enters the shooting range of the camera 106 and is shown in the image represented by the image data output from the camera 106. This causes a change in the image represented by the image data. When a difference occurs between the first cutout data and the second cutout data in this way, the processor 101 determines that there is a change in ACT26 and is YES, and proceeds to ACT28.

In ACT28, the processor 101 determines which of the objects cut out by the cutting out process of ACT24 is a newly inserted item.

In ACT29, the processor 101 executes a recognition process. The recognition process is a process of recognizing the object shown in the image as an item based on the cutout data regarding the object determined by ACT28. The recognition process includes a process for recognizing an item based on the appearance of the item (hereinafter, referred to as appearance recognition process), and a process for recognizing an item based on the item barcode displayed on the item (hereinafter, referred to as barcode recognition process or symbol recognition process). As the appearance recognition process, for example, an object recognition process using deep learning using CNN, which is a method suitable for image recognition, is assumed. Alternatively, the appearance recognition process may be performed by using a method such as OCR (optical character recognition) or feature-point matching. The item barcode to be subjected to the barcode recognition process is generally a one-dimensional barcode. However, such a barcode recognition process may be performed on another type of optically readable code, such as a two-dimensional code. Thus, the processor 101 executes the cart terminal program PRA to perform the above-described recognition processes on the images captured by the camera 106.

In ACT30, the processor 101 confirms whether the recognition in ACT29 has succeeded. The processor 101 then determines YES if it is successfully recognized, and proceeds to ACT31.

In ACT31, the processor 101 registers the item recognized by ACT29 as a transaction item. That is, for example, the processor 101 updates the transaction data DAA so as to include the item information of the item recognized by ACT29 as the item information of the transaction item. The processor 101 includes at least an item code as an identifier of the item in the item information. The processor 101 may include an item name, a unit price, and the like in the item information. Here, what kind of information is included in the item information by the processor 101 may be appropriately determined by, for example, a creator of the cart terminal program PRA. Thus, when the processor 101 executes information processing based on the cart terminal program PRA, the computer having the processor 101 as a central part functions as a registering unit.

In ACT32, the processor 101 updates the registration screen. For example, the processor 101 updates a registration screen to be displayed on the touch display 104 so as to represent a list updated to include the transaction item registered by ACT31.

The processor 101 then performs ACT27 in the same manner as described above, and then returns to ACT21 and ACT22 standby status.

When the recognition process in ACT29 has not succeeded in the recognition of the item, the processor 101 determines NO in ACT30 and proceeds to ACT41 in FIG. 5.

In ACT41, the processor 101 checks whether there are a plurality of candidate items that could not be narrowed down to one as a recognition result by the recognition process in ACT29 in FIG. 4. Then, the processor 101 determines YES if there are a plurality of corresponding candidate items, and proceeds to ACT42.

In ACT42, the processor 101 checks whether a plurality of candidate items are similar to each other. The processor 101 then determines YES if it is determined to be similar and proceeds to ACT43.

Now, the recognition failures in the recognition process in ACT29 in FIG. 4 are mainly considered as follows.

(a) The item barcode is not imaged well.

(b) The recognition by the appearance recognition process is difficult due to a situation in which the learning is insufficient or the feature is not registered in the recognition dictionary.

(c) Although the item can be recognized by the appearance recognition process, it is not possible to specify which item is because there is another item having a similar appearance.

If the cause of the recognition failure is (a) and (c), the processor 101 determines that both ACT41 and ACT42 are YES, and proceeds to ACT43. At this time, the processor 101 confirms that the item is suitable for the appearance recognition process.

In ACT43, the processor 101 initiates a first guidance operation. The first guidance operation is an operation for guiding a customer to change a shooting state of the item that has just been placed in the basket unit 930 by the camera 106. The first guidance operation is, for example, displaying on the touch display 104 a guidance screen in which a message such as “please change the method of placing the item in the basket now” is represented by characters. The first guidance action is the reproduction by the sound unit 105 of a voice representing a message similar to that described above. The first guidance operation may be performed by any one of the plurality of methods or by a combination of the plurality of methods.

On the other hand, the processor 101 determines NO at ACT41 or ACT42 when even candidate items are not found by the recognition process in ACT29 in FIG. 4, or when it is not possible to confirm that a plurality of candidate items are similar to each other, and proceeds to ACT44.

If the cause of the recognition failure is (a) and (b), the processor 101 determines NO in ACT41 or ACT42. At this time, the processor 101 does not determine that the item is suitable for the appearance recognition process by the first recognition unit.

In ACT44, the processor 101 initiates a second guidance operation. The second guidance operation is an operation for guiding the customer to scan the item barcode of the item immediately before placed in the basket unit 930 on the camera 106. The second guidance operation is, for example, displaying on the touch display 104 a guidance screen in which a message such as “please scan a barcode of the item placed in the basket now with the camera” is represented by characters. The second guidance operation is the reproduction of a voice representing a message similar to that described above. The second guidance operation may be performed by any one of the plurality of methods or by a combination of the plurality of methods. In the second guidance operation, it is preferable that the image captured by the camera 106 is displayed on the touch display 104 in real time. As a result, the customer can confirm the situation in which the item barcode is shown in the image captured by the camera 106.

Upon completion of ACT43 or ACT44, the processor 101 proceeds to ACT45 in any event.

In ACT45, the processor 101 waits for the acquisition timing. Then, the processor 101 determines YES when it is the acquisition timing, and proceeds to ACT46.

In ACT46, the processor 101 acquires the image data in the same manner as ACT15 in FIG. 3.

In ACT47, the processor 101 performs a cutting out process in the same manner as ACT16 in FIG. 3.

In ACT48, the processor 101 stores the data representing the result of the cutting out process in ACT47 in the memory 102 or the storage device 103 as the second cutout data.

In ACT49, the processor 101 checks whether there is a change in the second cutout data with respect to the first cutout data. Then, if there is no difference between the first cutout data and the second cutout data, the processor 101 determines NO and proceeds to ACT50.

In ACT50, the processor 101 rewrites the second cutout data as new first cutout data. The processor 101 then returns to ACT45 standby status.

Thus, the processor 101 waits for a change in the cutout data to occur due to a response by the customer in response to the first guidance action or the second guidance action.

When the customer performs a treatment in accordance with the first guidance operation or the second guidance operation, a change occurs in the shooting state of the corresponding item in the camera 106, and a change occurs in the cutout data. In response, the processor 101 determines YES in ACT49 and proceeds to ACT51.

In ACT51, the processor 101 deactivates the first guidance operation or the second guidance operation. Then, the processor 101 performs ACT28 and the subsequent steps in FIG. 4 in the same manner as described above.

When the registration of the transaction item is completed, the customer performs a predetermined operation for starting a payment process, for example, on the touch display 104. In response, the processor 101 determines YES in ACT22 in FIG. 4, and proceeds to the payment process. The payment process may be a process similar to that performed in a conventional cart POS system. The illustration thereof is omitted. For example, the processor 101 performs a process for transferring transaction data to the payment machine 200 for the payment process. Alternatively, if a payment terminal (not shown) is attached to the cart 900 and the payment terminal is connected to the cart terminal 100, processes for performing credit payment, code payment, or the like using the payment terminal may be performed as the payment process.

In this way, in the transaction processing system 1, the cart terminal 100 performs the first guidance operation for guiding the customer to change the state of the corresponding item on the image if the item is suitable for recognition by the appearance recognition process, and performs the second guidance operation for guiding the customer to scan the item barcode attached to item if the item is not suitable for recognition by the appearance recognition process. This allows the customer to accurately recognize how to treat in response to a failure in recognition, and allows the customer to perform such treatment.

In addition, the cart terminal 100 performs the appearance recognition process and the barcode recognition process with respect to an image captured by the camera 106. For this reason, in the case where the customer performs the treatment according to either the first guidance operation or the second guidance operation, it is only necessary to change the shooting state by the camera 106, and it is not necessary to greatly move the corresponding item.

Various modifications can be made to this embodiment as follows.

The barcode recognition process may be performed only in the recognition process performed after the first guidance operation or the second guidance operation is performed. That is, for example, when the processor 101 proceeds to ACT29 through ACT28 by determining YES in ACT26 in FIG. 4, ACT29 performs an appearance-recognition process. When the processor 101 proceeds from ACT51 in FIG. 5 to ACT29 through ACT28 in FIG. 4, it performs the appearance recognition process and the barcode recognition process as ACT29.

When the processor 101 proceeds from ACT51 in FIG. 5 to ACT29 via ACT28 in FIG. 4, ACT29 may be either the appearance recognition process or the barcode recognition process. In other words, the processor 101 performs the appearance recognition process as an ACT29 when the first guidance operation started in ACT43 in FIG. 5 is stopped by ACT51 and then proceeds to ACT29 via ACT28 in FIG. 4. Further, the processor 101, after stopping the second guidance operation started in ACT44 in FIG. 5 in ACT51, when proceeding to ACT29 via ACT28 in FIG. 4, performs the barcode recognizing process as an ACT29.

For example, a camera unit separate from the cart terminal 100 may be attached to the handle frame unit 920, the basket unit 930, the support unit 940, or the like of the cart 900, and the image data output from the camera unit may be used instead of the image data output from the camera 106.

Another camera different from the camera 106 may be attached to the cart 900, and an image captured by the other camera may be processed by the barcode recognition process.

Another device such as a laser scanner that detects a pattern of an item barcode may be further attached to the cart 900, and the barcode recognition process may be performed based on a result of the reading by the other device.

The cart terminal 100 in one embodiment may be implemented as an item recognition device which is used in combination with another item registration device, a transaction processing device, or the like, and whose main function is to recognize an item.

The recognition result of the item is not limited to the registration of the transaction item for the transaction processing, and may be used for any purpose.

The cart terminal may recognize objects other than items sold at a store.

A part of the process executed by the processor 101 may be executed by the POS server 400 or any one or a plurality of other information processing apparatuses. For example, the cart terminal 100 may mainly perform a user-interface operation, and many pieces of information related to the registration process may be managed by the POS server 400.

Each of the above-described functions may be performed by hardware not based on a program such as a logic circuit or the like. Each of the above-described functions can also be performed by a combination of software and hardware such as the above-described logic circuit.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A point-of-sale (POS) terminal for registering an item for purchase at a store, comprising:
a display;
a camera; and
a processor configured to:
control the camera to capture an image,
determine whether an object is present in the image,
upon determining that an object is present in the image, execute a recognition process on the image, the recognition process including an appearance recognition process for recognizing the object based on an appearance thereof and a symbol recognition process for recognizing the object using a symbol attached thereto,
when a single candidate item is output through the recognition process, register the single candidate item as an item to be purchased, and
when two or more candidate items are output through the recognition process,
determine whether the two or more candidate items have similar appearances,
upon determining that the two or more candidate items have similar appearances, control the display to display a first guidance screen with an instruction to change a position or orientation of the object in the image, and then execute the recognition process again, and
upon determining that the two or more candidate items do not have similar appearances, control the display to display a second guidance screen with an instruction to turn a symbol attached to the object towards the camera, and then execute the recognition process again.

2. The POS terminal according to claim 1, wherein the processor is configured to, when no candidate item is output through the recognition process, control the display to display the second guidance screen, and then execute the recognition process again.

3. The POS terminal according to claim 2, wherein the symbol includes a barcode.

4. The POS terminal according to claim 1, wherein after the first or second guidance screen is displayed, the processor performs the recognition process again upon detection of a change in the image captured by the camera.

5. The POS terminal according to claim 1, wherein the processor is configured to, before performing the recognition process, determine a part of the captured image in which the object is present, and then crop the part from the captured image so that the recognition process is performed on the cropped part.

6. The POS terminal according to claim 1, wherein
the POS terminal is attachable to a shopping cart, and
the camera is disposed to capture an image of a basket of the shopping cart.

7. The POS terminal according to claim 6, wherein the processor determines that an object is present in the image when the object is a new object not present in a previously captured image.

8. A method for registering an item for purchase at a store, comprising:
controlling a camera to capture an image;
determining whether an object is present in the image;
upon determining that an object is present in the image, executing a recognition process on the image, the recognition process including an appearance recognition process for recognizing the object based on an appearance thereof and a symbol recognition process for recognizing the object using a symbol attached thereto;
when a single candidate item is output through the recognition process, registering the single candidate item as an item to be purchased; and
when two or more candidate items are output through the recognition process,
determining whether the two or more candidate items have similar appearances,
upon determining that the two or more candidate items have similar appearances, controlling a display to display a first guidance screen with an instruction to change a position or orientation of the object in the image, and then executing the recognition process again, and
upon determining that the two or more candidate items do not have similar appearances, controlling the display to display a second guidance screen with an instruction to turn a symbol attached to the object towards the camera, and then executing the recognition process again.

9. The method according to claim 8, further comprising:
when no candidate item is output through the recognition process, controlling the display to display the second guidance screen, and then executing the recognition process again.

10. The method according to claim 9, wherein the symbol includes a barcode.

11. The method according to claim 8, wherein after the first or second guidance screen is displayed, the recognition process is performed again upon detection of a change in the image captured by the camera.

12. The method according to claim 8, further comprising:
before performing the recognition process, determining a part of the captured image in which the object is present, and then cropping the part from the captured image so that the recognition process is performed on the cropped part.

13. The method according to claim 8, wherein the camera is disposed to capture an image of a basket of a shopping cart.

14. The method according to claim 13, wherein an object is determined to be present in the image when a new object is in the image.

15. A non-transitory computer readable medium storing a program causing a computer to execute a method for registering an item for purchase at a store, the method comprising:
controlling a camera to capture an image;
determining whether an object is present in the image;
upon determining that an object is present in the image, executing a recognition process on the image, the recognition process including an appearance recognition process for recognizing the object based on an appearance thereof and a symbol recognition process for recognizing the object using a symbol attached thereto;
when a single candidate item is output through the recognition process, registering the single candidate item as an item to be purchased; and
when two or more candidate items are output through the recognition process,
determining whether the two or more candidate items have similar appearances,
upon determining that the two or more candidate items have similar appearances, controlling a display to display a first guidance screen with an instruction to change a position or orientation of the object in the image, and then executing the recognition process again, and
upon determining that the two or more candidate items do not have similar appearances, controlling the display to display a second guidance screen with an instruction to turn a symbol attached to the object towards the camera, and then executing the recognition process again.

16. The computer readable medium according to claim 15, wherein the method further comprises:
when no candidate item is output through the recognition process, controlling the display to display the second guidance screen, and then executing the recognition process again.

17. The computer readable medium according to claim 16, wherein the symbol includes a barcode.

18. The computer readable medium according to claim 15, wherein after the first or second guidance screen is displayed, the recognition process is performed again upon detection of a change in the image captured by the camera.

19. The computer readable medium according to claim 15, wherein the method further comprises:
before performing the recognition process, determining a part of the captured image in which the object is present, and then cropping the part from the captured image so that the recognition process is performed on the cropped part.

20. The computer readable medium according to claim 15, wherein the camera is disposed to capture an image of a basket of a shopping cart.
